(19) United States
(12) Patent Application Publication
(10) Pub. No.: US 2012/0154378 A1
(43) Pub. Date: Jun. 21, 2012

(54) DETERMINING DEVICE MOVEMENT AND ORIENTATION FOR THREE DIMENSIONAL VIEWS

(75) Inventor: Stephen Kitchens, San Francisco, CA (US)

(73) Assignee: SONY ERICSSON MOBILE COMMUNICATIONS AB, Lund (SE)

(21) Appl. No.: 13/142,433

(22) PCT Filed: Dec. 20, 2010
(86) PCT No.: PCT/US10/61276

§ 371 Date: Jun. 28, 2011

(51) Int. Cl. G06F 3/041

(52) U.S. Cl. 345/419

(57) ABSTRACT

A device may include a first sensor, a display, and a processor. The first sensor may track orientation and location of the device. The display may include a plurality of pixels and light guides. Each light guide may be configured to direct light rays from a first sub-pixel within a pixel and a second sub-pixel within the pixel to a right eye and a left eye, respectively, of a viewer. The processor may be configured to select a sweet spot based on viewer input, obtain a relative location of the device based on output of the first sensor, and determine a stereoscopic image that is to be viewed at the sweet spot, the stereoscopic image including a right-eye image and a left-eye image. The processor may be further configured to display, based on the orientation and position of the device, the right-eye image for viewing by the right eye via a first set of sub-pixels and the left-eye image for viewing by the left eye via a second set of sub-pixels.

### BACKGROUND

A three-dimensional (3D) display may provide a stereoscopic effect (e.g., an illusion of depth) by rendering two slightly different images, one image for the right eye (e.g., a right-eye image) and the other image for the left eye (e.g., a left-eye image) of a viewer. When each of the eyes sees its respective image on the display, the viewer may perceive a stereoscopic image.

### SUMMARY

According to one aspect, a method may include receiving a user input for selecting a sweet spot for viewing three-dimensional images on a display of a device, determining a position and orientation of the device to obtain first position information and orientation information, determining a position of a user relative to the device to obtain second position information, obtaining a stereoscopic image that is to be viewed by the user at the position of the user, the stereoscopic image consisting of a right-eye image and a left-eye image; and transmitting the stereoscopic image from the device to the user based on the selected sweet spot, the first position information, the orientation information, and the second position information.

Additionally, selecting the sweet spot may include directing the stereoscopic image to be viewed at a location of the user at a time the sweet spot is selected.

Additionally, determining the position and orientation of the device may include obtaining information from a gyroscope included in the device.

Additionally, determining the position of the user may include tracking a location of the user via a proximity sensor or tracking locations of the user's eyes via one or more cameras.

Additionally, obtaining the stereoscopic image may include determining a projection of a virtual, three-dimensional object, which is stored in a memory of a device, onto a surface of the display, to obtain the right-eye image or receiving the right-eye image from a three-dimensional multimedia content.

Additionally, transmitting the stereoscopic image may include controlling a light guide to direct light rays from a picture element of the right-eye image on the display to a right eye of the user and not to a left eye of the user.

Additionally, the method may further include displaying, on the display, the right-eye image via a first set of sub-pixels that are visible to a right eye of the user and the left-eye image via a second set of sub-pixels that are visible to a left eye of the user.

Additionally, transmitting the stereoscopic image may include determining angles at which light guides for pixels of the display of the device redirect light rays from the pixels, based on the sweet spot, the first position information and orientation information, and the second position information.

Additionally, receiving the user input may include storing parameters, at a time that the user selects the sweet spot, that are associated with directions in which light guides are set to send images on the display of the device.

Additionally, the method may further include sending a second stereoscopic image from the device to a second user concurrently to the transmission of the stereoscopic image to the user.

According to another aspect, a device may include a first sensor for tracking orientation and location of the device and a display including a plurality of pixels and light guides. Each light guide may be configured to direct light rays from a first sub-pixel within a pixel and a second sub-pixel within the pixel to a right eye and a left eye, respectively, of a viewer. The device may include a processor to select a sweet spot based on viewer input, obtain a relative location of the device based on output of the first sensor, and determine a stereoscopic image that is to be viewed at the sweet spot, the stereoscopic image including a right-eye image and a left-eye image. The processor may also be configured to display, based on the orientation and position of the device, the right-eye image for viewing by the right eye via a first set of sub-pixels and the left-eye image for viewing by the left eye via a second set of sub-pixels.

Additionally, the device may include a tablet computer; a cell phone; a laptop computer; a personal digital assistant; a gaming console; or a personal computer.

Additionally, the first sensor may include at least a gyroscope or an accelerometer.

Additionally, when the processor is configured to display, the processor may be further configured to reconfigure, based on the orientation and location of the device, light guides on the display to send the stereoscopic image to the viewer when the stereoscopic image is displayed on the display.

Additionally, the light guide may include at least one of: a lenticular lens or a parallax barrier.

Additionally, the parallax barrier may be configured to: modify a direction of a light ray from the first sub-pixel based on the orientation and location of the device.

Additionally, the device may further include a second sensor for tracking a location the viewer, wherein when the processor is configured to display, the processor is further configured to reconfigure, based on the orientation and location of the device and the tracked location of the viewer, light guides on the display to send the stereoscopic image to the viewer when the stereoscopic image is displayed on the display.

Additionally, the sensor may include at least one of: an ultrasonic sensor, an infrared sensor, a camera sensor, or a heat sensor.

Additionally, the right-eye image may include an image obtained from three-dimensional multimedia content, or a projection of a three-dimensional virtual object onto the display.

According to yet another aspect, a computer-readable medium may include computer-executable instructions for causing one or more processors to receive a user input for selecting a sweet spot for viewing three-dimensional images on a display of a device, determine position and orientation of the device to obtain first position information and orientation information, determine a position of a user relative to the device to obtain second position information, obtain a stereoscopic image that is to be viewed by the user at the position of the user, the stereoscopic image including a right-eye image and a left-eye image, and transmit the stereoscopic image from the device to the user based on the selected sweet spot, the first position information, the orientation information, and the second position information.

### BRIEF DESCRIPTION OF THE DRAWINGS

The accompanying drawings, which are incorporated in and constitute a part of this specification, illustrate one or more embodiments described herein and, together with the description, explain the embodiments. In the drawings:

FIG. 1 is a diagram illustrating an overview of a three-dimensional (3D) system in which concepts described herein may be implemented;

FIG. 2 is a diagram of the exemplary 3D system of FIG. 1;

FIGS. 3A and 3B are front and rear views of one implementation of an exemplary device of FIG. 1;

FIG. 4 is a block diagram of components of the exemplary device of FIG. 1;

FIG. 5 is a functional block diagram of the exemplary device of FIG. 1;

FIG. 6 is a flow diagram of an exemplary process for displaying 3D views by determining the orientation and location of the device of FIGS. 3A and 3B;

FIG. 7 is a diagram illustrating operation of another implementation of the device of FIG. 1; and

FIG. 8 shows a scenario that illustrates the process of FIG. 6.

### DETAILED DESCRIPTION

The following detailed description refers to the accompanying drawings. The same reference numbers in different drawings may identify the same or similar elements. In addition, the terms “viewer” and “user” are used interchangeably.

### Overview

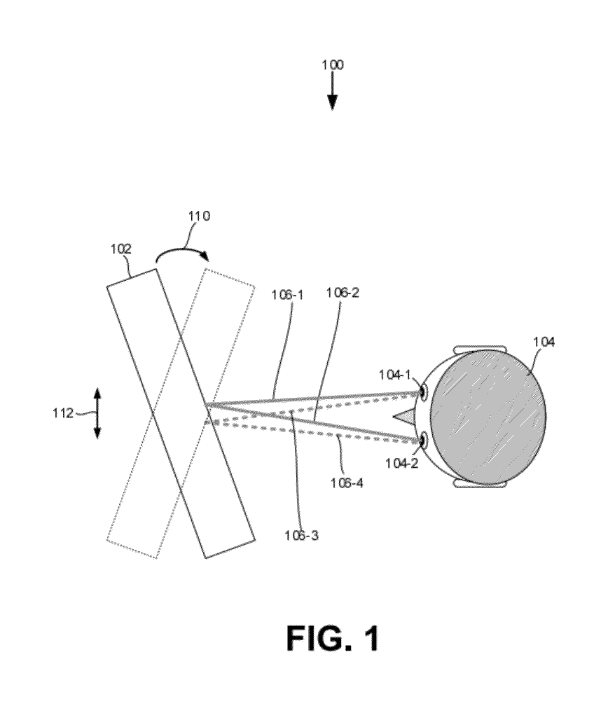

Aspects described herein provide a visual three-dimensional (3D) effect based on device and viewer tracking FIG. 1 is a simplified diagram of an exemplary 3D system 100 in which concepts described herein may be implemented. As shown, 3D system 100 may include a device 102 and a viewer 104. Device 102 may generate and provide two-dimensional (2D) or 3D images to viewer 104 via a display. When device 102 shows a 3D image, viewer 104 may receive a right-eye image and a left-eye image via light rays 106-1 and 106-2. Light rays 106-1 and 106-2 may carry different visual information, such that, together, they provide a stereoscopic image to viewer 104.

In FIG. 1, device 102 may not radiate or transmit the left-eye image and the right eye image in an isotropic manner. Accordingly, at certain locations, viewer 104 may receive the best-quality stereoscopic image that device 102 is capable of conveying. At other locations, viewer 104 may receive incoherent images. As used herein, the term “sweet spots” may refer to locations at which viewer 104 can perceive relatively high quality stereoscopic images.

In some situations, device 102 may change its position, possibly due to a rotation, as illustrated by arrow 110, or due to a translation, as illustrated by arrow 112. These movements may be caused by vibrations (e.g., device 102 is in an automobile or in a viewer's hand) or other motions. When device 102 moves in such a manner, for device 102 to convey the 3D image, device 102 may need to emit light rays 106-3 and 106-4 in place of light rays 106-1 and 106-2 to right-eye 104-1 and left-eye 104-2 of viewer 104, respectively. To accomplish the preceding, device 102 may track the orientation and position of device 102, as well as the location of viewer 104 relative to device 102, for example, by using proximity sensors. When device 102 detects that viewer 104's relative location has changed, device 102 may redirect right-eye and left-eye images as light rays 106-3 and 106-4 by adjusting three dimensional (3D) light guides on device 102.

### Exemplary 3D System

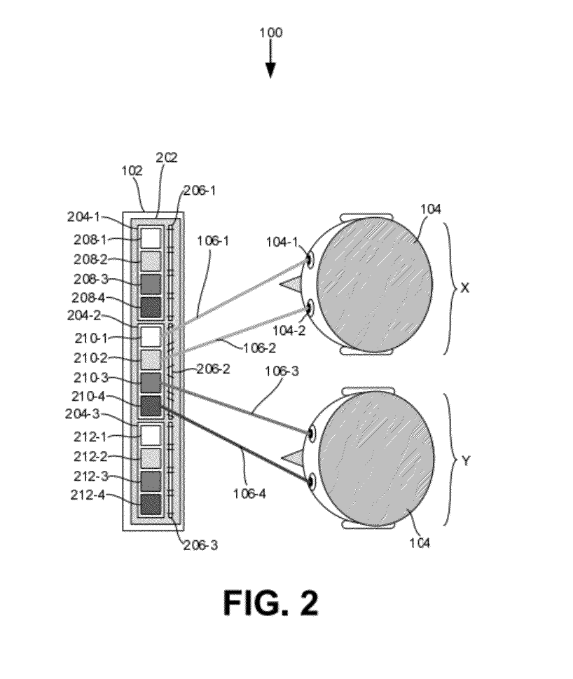

FIG. 2 is an exemplary diagram of the 3D system of FIG. 1. As shown in FIG. 2, 3D system 100 may include device 102 and viewer 104. Device 102 may include any of the following devices that have the ability to or are adapted to display 2D and 3D images, such as a cell phone or a mobile telephone with a 3D display (e.g., smart phone); a tablet computer; an electronic notepad, a gaming console, a laptop, and/or a personal computer with a 3D display; a personal digital assistant (PDA) that can include a 3D display; a gaming device or console with a 3D display; a peripheral (e.g., wireless headphone, wireless display, etc.); a digital camera; or another type of computational or communication device with a 3D display, etc.

As further shown in FIG. 2, device 102 may include a 3D display 202. 3D display 202 may show 2D/3D images that are generated by device 102. Viewer 104 in location X may perceive light rays through a right eye 104-1 and a left eye 104-2. Viewer 104 may change its relative location with respect to device 102 from location X, for example, to location Y, due to various factors, such as a movement of device 102 as illustrated in FIG. 1 or a movement of viewer 104.

As also shown in FIG. 2, 3D display 202 may include picture elements (pixels) 204-1, 204-2 and 204-3 (hereinafter collectively referred to as pixels 204) and light guides 206-1, 206-2, and 206-3 (herein collectively referred to as light guides 206). Although 3D display 202 may include additional pixels, light guides, or different components (e.g., a touch screen, circuit for receiving signals from a component in device 102, etc.), they are not illustrated in FIG. 2 for simplicity.

In 3D display 202, pixel 204-2 may generate light rays 106-1 through 106-4 (herein collectively referred to as light rays 106 and individually as light ray 106-x) that reach viewer 104 via light guide 206-2. Light guide 206-2 may guide light rays 106 from pixel 204-2 in specific directions relative to the surface of 3D display 202.

As further shown in FIG. 2, pixel 204-2 may include sub-pixels 210-1 through 210-4 (herein collectively referred to as sub-pixels 210 and individually as sub-pixel 210-x). In a different implementation, pixel 204-2 may include fewer or additional sub-pixels.

To show a 3D image on 3D display 202, sub-pixels 210-1 through 210-4 may generate light rays 106-1 through 106-4, respectively. When sub-pixels 210 generate light rays 106, light guide 206-2 may direct each of light rays 106 on a path that is different from the paths of other rays 106. For example, in FIG. 2, light guide 206-2 may guide light ray 106-1 from sub-pixel 210-1 toward right-eye 104-1 of viewer 104 and light ray 106-2 from sub-pixel 210-2 toward left-eye 104-2 of viewer 104.

In FIG. 2, pixels 204-1 and 204-3 may include similar components as pixel 204-2 (e.g., sub-pixels 208-1 through 208-4 and sub-pixels 212-1 through 212-4, respectively), and may operate similarly as pixel 204-2. Thus, right-eye 104-1 may receive not only light ray 106-1 from sub-pixel 210-1 in pixel 204-2, but also light rays from corresponding sub-pixels in pixels 204-1 and 204-3 (e.g., sub-pixels 208-1 and 212-1). Left-eye 104-2 may receive not only light ray 106-2 from sub-pixel 210-2 in pixel 204-2, but also light rays from corresponding sub-pixels in pixels 204-1 and 204-3 (e.g., sub-pixels 208-2 and 212-2).

In the above, if a right-eye image of a stereoscopic image is displayed via sub-pixels 208-1, 210-1 and 212-1, and a left-eye image is displayed via sub-pixels 208-2, 210-2, and 212-2, right-eye 104-1 and left-eye 104-2 may see the right-eye image and the left-eye image, respectively. Consequently, viewer 104 may perceive a stereoscopic image at location X.

In FIG. 2, when the relative location of viewer 104 changes from location X to location Y (e.g., due to a rotation/translation of device 102), for 3D display 202 to aid viewer 104 to stay in a sweet spot, 3D display 202 may need to redirect right- and left-eye images that are transmitted to location X. To accomplish the preceding, device 104 may track its own location and orientation, as well as the location of viewer 104 via sensors. When device 102 detects that viewer 104's relative location has changed from location X to location Y, device 102 may adjust the directions in which right-eye and left-eye images are sent, and cause 3D display 202 to show the appropriate right-eye and left-eye images to viewer 104 at location Y. For example, in FIG. 2, when viewer 104 is at location Y, device 102 cause light guides 206 to direct light rays from sub-pixels 208-3, 210-3, and 212-3 to display the right-eye image, and sub-pixels 208-4, 210-4, and 210-4 to display the left-eye image.

### Exemplary Device

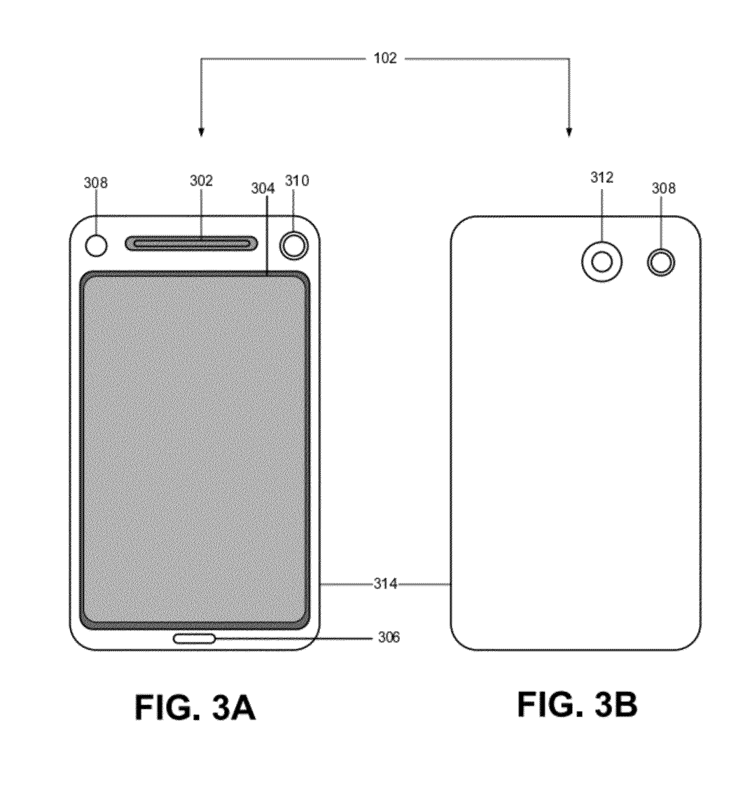

FIGS. 3A and 3B are front and rear views, respectively, of one implementation of device 102. In this implementation, device 102 may take the form of a portable phone (e.g., a smart phone). As shown in FIGS. 3A and 3B, device 102 may include a speaker 302, a display 304, a microphone 306, sensors 308, a front camera 310, a rear camera 312, and housing 314.

Speaker 302 may provide audible information to a user/viewer of device 102. Display 304 may provide two-dimensional or three-dimensional visual information to the user. Examples of display 304 may include an auto-stereoscopic 3D display, a stereoscopic 3D display, a volumetric display, etc. Display 304 may include pixel elements that emit different light rays to viewer 104's right eye 104-1 and left eye 104-2, through a matrix of light guides 206 (FIG. 2) (e.g., a lenticular lens, a parallax barrier, etc.) that cover the surface of display 304. In one implementation, light guide 206-x may dynamically change the directions in which the light rays are emitted from the surface of display 304, depending on input from device 102. In some implementations, display 304 may also include a touch-screen, for receiving user input.

Microphone 306 may receive audible information from the user. Sensors 308 may collect and provide, to device 102, information pertaining to itself, information that is used to aid viewer 104 in capturing images (e.g., for providing information for auto-focusing to lens assembly 314) and/or information tracking viewer 104 (e.g., proximity sensor). For example, sensor 308 may provide acceleration and orientation of device 102 to internal processors. In another example, sensors 308 may provide the distance and the direction of viewer 104 relative to device 102, so that device 102 may determine two-dimensional (2D) projections of virtual 3D objects onto display 304. Examples of sensors 308 include an accelerometer, gyroscope, ultrasound sensor, an infrared sensor, a camera sensor, a heat sensor/detector, etc.

Front camera 310 and rear camera 312 may enable a user to view, capture, store, and process images of a subject in/at front/back of device 102. Front camera 310 may be separate from rear camera 312 that is located on the back of device 102. In some implementations, device 102 may include yet another camera at either the front or the back of device 102, to provide a pair of 3D cameras on either the front or the back. Housing 314 may provide a casing for components of device 102 and may protect the components from outside elements.

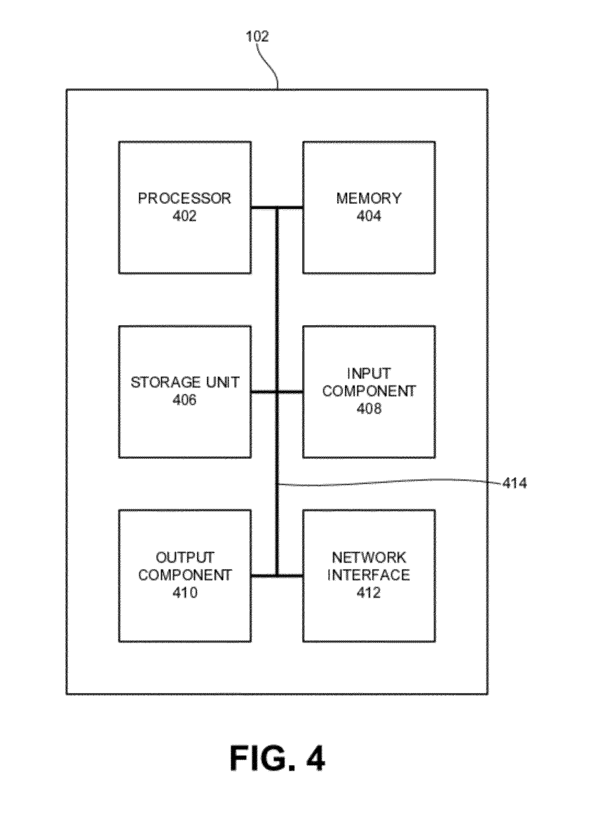

FIG. 4 is a block diagram of device 102. As shown, device 102 may include a processor 402, a memory 404, input/output components 406, a network interface 408, and a communication path 410. In different implementations, device 102 may include additional, fewer, or different components than the ones illustrated in FIG. 4.

Processor 402 may include a processor, a microprocessor, an Application Specific Integrated Circuit (ASIC), a Field Programmable Gate Array (FPGA), and/or other processing logic capable of controlling device 102. In one implementation, processor 402 may include components that are specifically designed to process 3D images. Memory 404 may include static memory, such as read only memory (ROM), and/or dynamic memory, such as random access memory (RAM), or onboard cache, for storing data and machine-readable instructions.

Storage unit 406 may include a magnetic and/or optical storage/recording medium. In some embodiments, storage unit 206 may be mounted under a directory tree or may be mapped to a drive. Depending on the context, the term “medium,” “memory,” “storage,” “storage device,” “storage medium,” and/or “storage unit” may be used interchangeably. For example, a “computer-readable storage device” or “computer readable storage medium” may refer to both a memory and/or storage device.

Input component 408 may permit a user to input information to device 102. Input component 408 may include, for example, a keyboard, a keypad, a mouse, a pen, a microphone, a touch screen, voice recognition and/or biometric mechanisms, sensors, etc. Output component 410 may include a mechanism that outputs information to the user. Output component 410 may include, for example, a display, a printer, a speaker, etc.

Network interface 412 may include any transceiver-like mechanism that enables device 102 to communicate with other devices and/or systems. For example, network interface 412 may include mechanisms for communicating via a network, such as the Internet, a terrestrial wireless network (e.g., a WLAN), a satellite-based network, a WPAN, etc. Additionally or alternatively, network interface 412 may include a modem, an Ethernet interface to a LAN, and/or an interface/connection for connecting device 102 to other devices (e.g., a Bluetooth interface).

Communication path 414 may provide an interface through which components of device 102 can communicate with one another.

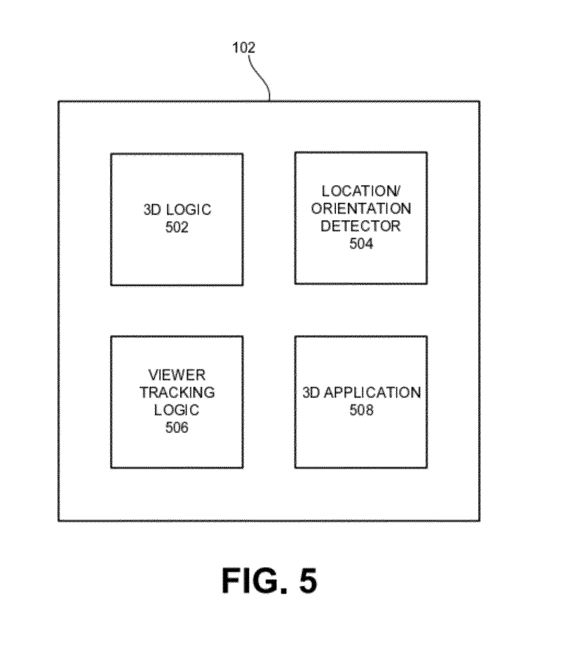

FIG. 5 is a functional block diagram of device 102. As shown, device 102 may include 3D logic 502, location/orientation detector 504, viewer tracking logic 506, and 3D application 508. Although not illustrated in FIG. 5, device 102 may include additional functional components, such as the components that are shown in FIG. 4, an operating system (e.g., Windows Mobile OS, Blackberry OS, Linux, Android, iOS, Windows Phone, etc.), an application (e.g., an instant messenger client, an email client, etc.), etc.

3D logic 502 may include hardware and/or software components for obtaining right-eye images and left-eye images and/or providing the right/left-eye images to a 3D display (e.g., display 304). In obtaining the right-eye and left-eye images, 3D logic 502 may receive right- and left-eye images from stored media content (e.g., a 3D movie). In other implementations, 3D logic 502 may generate the right and left-eye images of a 3D model or object for different sub-pixels. In such instances, device 102 may obtain projections of the 3D object onto 3D display 202.

In projecting the 3D object onto 3D display 202, device 102 may determine, for each point on the surface of the 3D object, a pixel on display 202 through which a ray from the point would reach left eye 104-2 and determine parameters that may be set for the pixel to emit a light ray that would appear as if it were emitted from the point. For device 102, a set of such parameters for pixels in a viewable area within the surface of 3D display 202 may correspond to a left-eye image.

Once the left-eye image is determined, device 102 may display the left-eye image on 3D display 202. To display the left-eye image, device 102 may select, for each of the pixels in the viewable area, a sub-pixel whose emitted light will reach left eye 104-2. When device 102 sets the determined parameters for the selected sub-pixel within each of the pixels, left eye 104-2 may perceive the left-eye image from the surface of 3D display 202. Because light rays from the selected sub-pixels do not reach right eye 104-1, right eye 104-1 may not perceive left-eye image. Device 102 may generate an image for right eye 104-1 in a manner similar to that for the left-eye image. When right eye 104-1 and left eye 104-2 see the right-eye image and left-eye image, respectively, viewer 104 may perceive a stereoscopic or 3D image.

In some implementations, 3D logic 502 may receive viewer input for selecting a sweet spot. In one implementation, when a viewer selects a sweet spot (e.g., by pressing a button on device 102), device 102 may store parameter values that characterize light guides 206, the location/orientation of user device 102, and/or the relative location of viewer 104. In another implementation, when the user selects a sweet spot, the device may recalibrate its light guides such that the stereoscopic images are sent to the selected spot. In either case, as the viewer's relative location deviates from the established sweet spot, 3D logic 502 may determine (e.g., calculate) changes in directions to which light rays must be emitted via light guides 206.

In some implementations, the orientation of device 102 may affect the relative location of sweet spots. Accordingly, making proper adjustments to the angles at which the light rays from device 102 are guided, via light guides 206, may play an important role in locking the sweet spot for the viewer. The adjustments may be important, for example, when device 102 is relatively unstable (e.g., being held by a hand).

Returning to FIG. 5, location/orientation logic 504 may determine the location/orientation of device 102 and provide location/orientation information to 3D logic 502, viewer tracking logic 506, and/or 3D application 508. In one implementation, location/orientation logic 504 may obtain the information from or include a Global Positioning System (GPS) receiver, gyroscope, accelerometer, etc.

Viewer tracking logic 506 may include hardware and/or software (e.g., a range finder, proximity sensor, cameras, image detector, etc.) for tracking viewer 104 and/or part of viewer 104 (e.g., head, eyes, etc.) and providing the location/position of viewer 104 to 3D logic 502. In some implementations, viewer tracking logic 506 may include sensors (e.g., sensors 312) and/or logic for determining a location of viewer 104's head or eyes based on sensor inputs (e.g., distance information from sensors, an image of a face, an image of eyes 104-1 and 104-2 from cameras, etc.).

3D application 508 may include hardware and/or software that may show 3D images on 3D display 202. In showing the 3D images, 3D application may use 3D logic 502, location/orientation detector 504, and/or viewer tracking logic 506 to generate 3D images and/or provide the 3D images to 3D display 202. Examples of 3D application may include a 3D graphics game, a 3D movie player, etc.

### Exemplary Process for Displaying 3D Views Based on Device Tracking

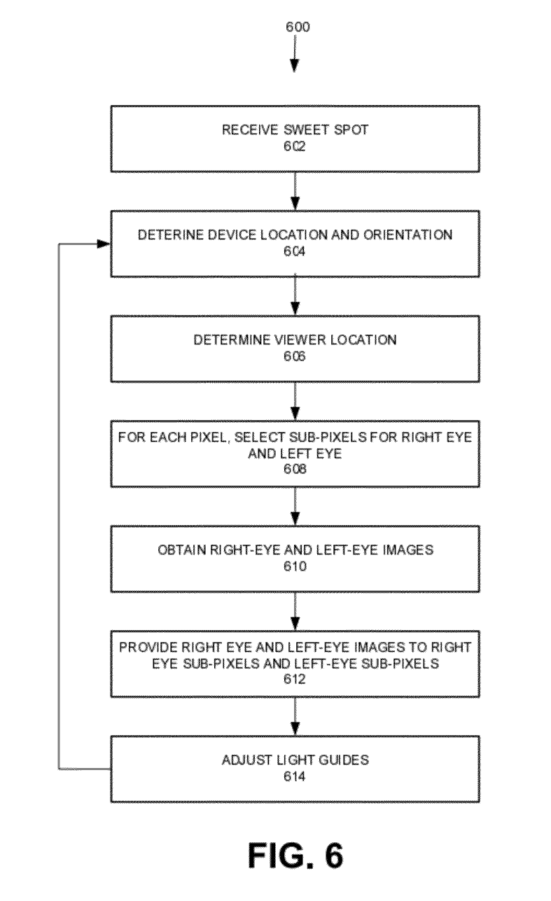

FIG. 6 is flow diagram of an exemplary process 600 for displaying 3D images based on tracking device location, orientation, and/or viewer 104. Assume that 3D logic 502 and/or 3D application 508 is executing on device 102. Process 600 may start at block 602, where 3D logic 502 may receive a viewer input for selecting a sweet spot (block 602). For example, viewer 104 may indicate that viewer 104 is in a sweet spot by pressing a button on device 102, touching soft switch on display 304 of device 102, etc. In response to the viewer input, 3D logic 502/3D application 508 may store the angles at which light guides 206 are sending light rays from sub-pixels, the location/orientation of device 102, the relative location of viewer 104 or part of viewer 104's body (e.g., viewer 104's head, viewer 104's eyes, etc.), identities of sub-pixels that are sending images to the right eye and of sub-pixels that are sending images to the left eye, etc.

Device 102 may determine device location and/or orientation (block 604). In one implementation, device 102 may obtain its location and orientation from location/orientation detector 504 (e.g., information from GPS receiver, gyroscope, accleratormete, etc.).

Device 102 may determine viewer location (block 606). Depending on the implementation, device 102 may determine the viewer location in one of several ways. For example, in one implementation, device 102 may use a proximity sensor to locate viewer 104. In another implementation, device 102 may sample images of viewer 104 (e.g., via cameras) and perform object detection (e.g., to locate the viewer's eyes, face, etc.).

Device 102 may select, for each pixel, sub-pixels for the right-eye and right-eye of viewer 104 (block 608). The sub-pixels for the right-eye and left-eye may be the sub-pixels that are identified at block 602. In a different implementation, device 102 may select different sub-pixels for sending the right-eye and left-eye images to viewer 104, depending on the relative orientation of display 102 with respect to viewer 104, the angle at which viewer 104 is looking at 3D display 202, etc.

For example, assume that sub-pixels 208-1, 210-1, and 212-1 were sending a right-eye image and sub-pixels 208-2, 210-2, and 212-2 were sending a left eye image to viewer 104. At block 608, device 102 may select sub-pixels 208-3, 210-3, and 210-3 for sending a right-eye image and sub-pixels 208-4, 210-4, and 212-4 for sending a left-eye image to viewer 104.

Device 102 may obtain right-eye and left-eye images (block 610). For example, in one implementation, 3D application 508 may obtain right-eye and left-eye images from a media stream from a content provider over a network. In another implementation, 3D application 508 may generate the images from a 3D model or object based on viewer 104's relative location from 3D display 202 or device 102.

Device 102 may provide the right-eye image and the left-eye image to the selected right- and left-eye sub-pixels (block 612) and adjust light guides 206 for the left-eye sub-pixels and right-eye sub-pixels (block 614). In some implementations, light guides 206 may be capable of directing light rays, at particular angles (e.g., determined by device 102 based on the position and orientation of device 102 and the location/orientation of viewer 104), from the sub-pixels that show the left-eye image to the left eye of viewer 104 and from the sub-pixels that show the right-eye image to the right eye of viewer 104.

Following block 614, process 600 may loop to block 604, to continue to track location/orientation of device 102 and viewer 104 and to send right-eye and left-eye images to viewer 104. The loop may terminate upon occurrences of different events, such as a termination of 3D application 508, turning off of device 102, etc.

### Alternative Implementation

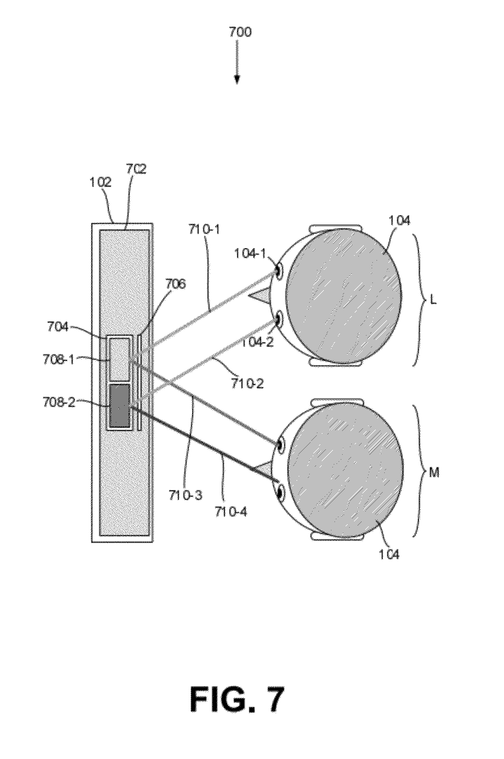

FIG. 7 is a diagram illustrating operation of an alternative implementation of device 102. As shown, device 102 may include 3D display 702. As further shown, 3D display 702 nay include pairs of pixels and light guides, one of which is illustrated as pixel 704 and light guide 706. In this implementation, pixel 704 may include sub-pixels 708-1 and 708-2.

In FIG. 7, sub-pixels 708-1 and 708-2 may emit light rays 710-1 and 710-2 to provide viewer 104 with a stereoscopic or 3D image. When viewer 104 moves from location L to location M, based on device 102/viewer tracking, device 102 may obtain or generate a new 3D image for viewer 104's location M relative to device 102, and cause light guide 706 to direct light rays 710-3 and 710-4 from sub-pixels 708-1 and 708-2 to viewer 104. Consequently, viewer 104 may perceive a 3D image that is consistent with location M.

In the above implementation, the number of sub-pixels is illustrated as two. However, depending on the number of viewers that display 702 is designed to concurrently track and support, display 702 may include additional pairs of sub-pixels. In such implementations, with additional sub-pixels, device 102 may obtain or generate additional images for the viewers at various locations.

In some implementations, the number of viewers that device 102 can support with respect to displaying 3D images may be greater than the number of sub-pixels within each pixel. For example, device 102 in FIG. 7 may track and provide images for two viewers, which is greater than two sub-pixels/number of eyes=2/2=1. In such an instance, device 102 may alternate stereoscopic images on display 702, such that each viewer perceives a continuous, coherent 3D image. Light guide 706 may be synchronized to the rate at which device 102 switches the stereoscopic images, to direct light rays from one of the stereoscopic images to a corresponding viewer at proper times.

### Example

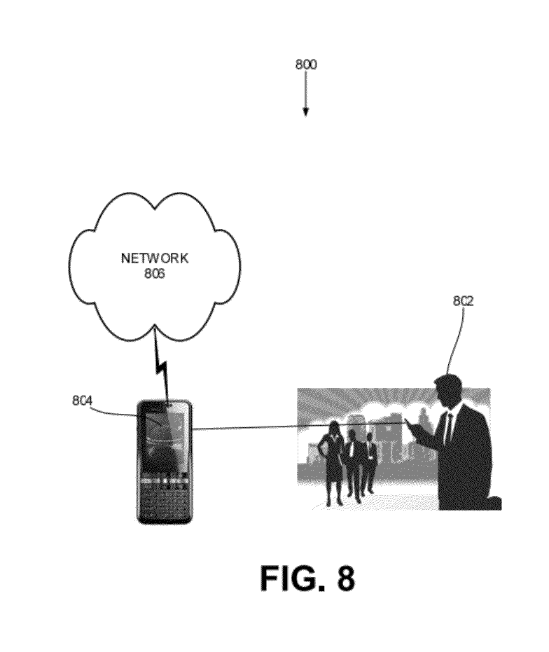

The following example, with reference to FIG. 8, illustrates process 600 described above. In the example, Stephen 802 is returning home from a business meeting. While he is waiting for his transportation, Stephen 802 uses a smart phone 804 to browse for an automobile. Stephen 802 visits an online car dealer over network 806. Stephen 802 views different types of cars. When Stephen sees a particular model and make that he likes, he requests a 3D image of the car via a browser installed on his phone 804. Stephen downloads a 3D model of the car.

Phone 804 determines the Stephen's location/orientation relative to phone 804, by tracking location/orientation of phone 804 and Stephen via its sensors. Based on the tracking information, phone 804 determines 2D projections of the car for the right- and left-eyes of Stephen, and displays the images for the right- and left-eyes onto the corresponding sub-pixels. Phone 804 sends the right-eye and left-eye images to Stephen's right eye and left eye, respectively. Consequently, Stephen sees a 3D image of the car.

As Stephen 802 moves his head or changes position of phone 804 to examine the car from different angles, location/orientation detector 504 and viewer tracking logic 506 in phone 804 tracks phone 804's relative orientation/location as well as the relative position of Stephen's head. 3D application 506 continuously generates 3D images of the car for Stephen's right-eye and left-eye. Stephen 802 is therefore able to view the car from different angles.

In the above example, device 102 may track its position/orientation as well as viewer 104. Based on the tracking information, device 102 generates 3D images. By obtaining/generating 3D images based on the device/viewer location/orientation, device 102 may be able to continuously provide a sweet spot for the viewer. Consequently, the viewer may be able to view and enjoy more realistic 3D images.

### CONCLUSION

The foregoing description of implementations provides illustration, but is not intended to be exhaustive or to limit the implementations to the precise form disclosed. Modifications and variations are possible in light of the above teachings or may be acquired from practice of the teachings.

In the above, while a series of blocks has been described with regard to exemplary processes 600 illustrated in FIG. 6, the order of the blocks in processes 600 may be modified in other implementations. In addition, non-dependent blocks may represent acts that can be performed in parallel to other blocks.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

It should be emphasized that the term “comprises/comprising” when used in this specification is taken to specify the presence of stated features, integers, steps or components but does not preclude the presence or addition of one or more other features, integers, steps, components, or groups thereof.

Further, certain portions of the implementations have been described as “logic” that performs one or more functions. This logic may include hardware, such as a processor, a microprocessor, an application specific integrated circuit, or a field programmable gate array, software, or a combination of hardware and software.

Even though particular combinations of features are recited in the claims and/or disclosed in the specification, these combinations are not intended to limit the invention. In fact, many of these features may be combined in ways not specifically recited in the claims and/or disclosed in the specification.

No element, act, or instruction used in the present application should be construed as critical or essential to the implementations described herein unless explicitly described as such. Also, as used herein, the article “a” is intended to include one or more items. Where one item is intended, the term “one” or similar language is used. Further, the phrase “based on” is intended to mean “based, at least in part, on” unless explicitly stated otherwise.

What is claimed is:

1. A method comprising:
receiving a user input for selecting a sweet spot for viewing three-dimensional images on a display of a device;
determining a position and orientation of the device to obtain first position information and orientation information;
determining a position of a user relative to the device to obtain second position information;
obtaining a stereoscopic image that is to be viewed by the user at the position of the user, the stereoscopic image consisting of a right-eye image and a left-eye image; and
transmitting the stereoscopic image from the device to the user based on the selected sweet spot, the first position information, the orientation information, and the second position information.

2. The method of claim 1, wherein selecting the sweet spot includes directing the stereoscopic image to be viewed at a location of the user at a time the sweet spot is selected.

3. The method of claim 1, wherein determining the position and orientation of the device includes obtaining information from a gyroscope included in the device.

4. The method of claim 1, wherein determining the position of the user includes:
tracking a location of the user via a proximity sensor; or
tracking locations of the user's eyes via one or more cameras.

5. The method of claim 1, wherein obtaining the stereoscopic image includes:
determining a projection of a virtual, three-dimensional object, which is stored in a memory of a device, onto a surface of the display, to obtain the right-eye image; or
receiving the right-eye image from a three-dimensional multimedia content.

6. The method of claim 1, wherein transmitting the stereoscopic image includes:
controlling a light guide to direct light rays from a picture element of the right-eye image on the display to a right eye of the user and not to a left eye of the user.

7. The method of claim 1, further comprising:
displaying, on the display, the right-eye image via a first set of sub-pixels that are visible to a right eye of the user, and the left-eye image via a second set of sub-pixels that are visible to a left eye of the user.

8. The method of claim 1, wherein transmitting the stereoscopic image includes:
determining angles at which light guides for pixels of the display of the device redirect light rays from the pixels, based on the sweet spot, the first position information and orientation information, and the second position information.

9. The method of claim 1, wherein receiving the user input includes:
storing parameters, at a time that the user selects the sweet spot, that are associated with directions in which light guides are set to send images on the display of the device.

10. The method of claim 1, further comprising:
sending a second stereoscopic image from the device to a second user concurrently to the transmission of the stereoscopic image to the user.

11. A device comprising:
a first sensor for tracking orientation and location of the device;
a display including a plurality of pixels and light guides, each light guide configured to:
direct light rays from a first sub-pixel within a pixel and a second sub-pixel within the pixel to a right eye and a left eye, respectively, of a viewer; and
a processor to:
select a sweet spot based on viewer input;
obtain a relative location of the device based on output of the first sensor;
determine a stereoscopic image that is to be viewed at the sweet spot, the stereoscopic image including a right-eye image and a left-eye image; and
display, based on the orientation and position of the device, the right-eye image for viewing by the right eye via a first set of sub-pixels and the left-eye image for viewing by the left eye via a second set of sub-pixels.

12. The device of claim 11, wherein the device includes:
a tablet computer; a cell phone; a laptop computer; a personal digital assistant; a gaming console; or a personal computer.

13. The device of claim 11, wherein the first sensor includes at least:
a gyroscope; or an accelerometer.

14. The device of claim 11, wherein when the processor is configured to display, the processor is further configured to:
reconfigure, based on the orientation and location of the device, light guides on the display to send the stereoscopic image to the viewer when the stereoscopic image is displayed on the display.

15. The device of claim 14, wherein the light guide includes at least one of: a lenticular lens; or a parallax barrier.

16. The device of claim 15, wherein the parallax barrier is configured to: modify a direction of a light ray from the first sub-pixel based on the orientation and location of the device.

17. The device of claim 11, further comprising:
a second sensor for tracking a location the viewer, wherein when the processor is configured to display, the processor is further configured to:
reconfigure, based on the orientation and location of the device and the tracked location of the viewer, light guides on the display to send the stereoscopic image to the viewer when the stereoscopic image is displayed on the display.

18. The device of claim 17, wherein the sensor includes at least one of: an ultrasonic sensor; an infrared sensor; a camera sensor; or a heat sensor.

19. The device of claim 11, where the right-eye image includes:
an image obtained from three-dimensional multimedia content; or
a projection of a three-dimensional virtual object onto the display.

20. A computer-readable medium comprising computer-executable instructions for causing one or more processors to:
receive a user input for selecting a sweet spot for viewing three-dimensional images on a display of a device;
determine position and orientation of the device to obtain first position information and orientation information;
determine a position of a user relative to the device to obtain second position information;
obtain a stereoscopic image that is to be viewed by the user at the position of the user, the stereoscopic image including a right-eye image and a left-eye image; and
transmit the stereoscopic image from the device to the user based on the selected sweet spot, the first position information, the orientation information, and the second position information.
